(19) United States
(12) Patent Application Publication
(10) Pub. No.: US 2008/0123224 A1
(43) Pub. Date: May 29, 2008

(54) Magnetoresistive element, magnetic head, and magnetic recording apparatus

(75) Inventor: Masanori Akie, Kawasaki-shi (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/985,949

(22) Filed: Nov. 19, 2007

(30) Foreign Application Priority Data
Nov. 28, 2006 (JP) 2006-319553

(51) Int. Cl. G11B 5/127; G11B 5/39

(52) U.S. Cl. 360/324.11; 428/811.2

(57) ABSTRACT

A magnetoresistive MR element 10, which is constituted by allocating a magnetic layer 22a, 22b between a sensing layer (free-magnetic layer) 11 whose magnetization rotates in response to an external magnetic field, and a bias application layer 15a, 15b for applying a bias magnetic field to the sensing layer (free-magnetic layer) 11. The components of the bias magnetic layer in the element height direction are cancelled and a stable bias magnetic field is applied to the sensing layer in the core width direction, and thereby Barkhausen noise can be prevented by forming small crystal grains with the magnetic layer 22a, 22b and transferring the bias magnetic field from the bias application layer 15a, 15b to the sensing layer (free-magnetic layer) 11 through such small crystal grains.

The present invention relates to a magneto-resistive element and more specifically to a structure of a bias application layer for applying a bias magnetic field to a sensing layer whose magnetization rotates in response to an external magnetic field.

### BACKGROUND OF THE INVENTION

FIG. 1 shows a structure of a magnetic head used in a magnetic disk drive. The magnetic head includes with a read head 4 and a write head 9. The read head 4 has a lower shield layer 1 and an upper shield layer 3 allocated to hold a magnetoresistive element 2 (AMR element, GMR element, TMR element) for reading. The write head 9 has a lower magnetic pole 5 (including the upper shield layer 3) and an upper magnetic pole 7 allocated to hold a write gap 6, and a coil 8 for recording.

FIG. 2 shows a giant magnetoresistive element of the prior art used for a magnetic head. FIG. 2 is a side elevation of the giant magnetoresistive element where the surface opposing a medium is viewed from the side of the medium. The element 10 for detecting magnetic fields includes a free-magnetic layer 11 as the sensing layer, a pinned-magnetic layer 12, an anti-ferro-magnetic layer 13 for fixing the pinned-magnetic layer 12, and a non-magnetic layer 14 provided between the free-magnetic layer 11 and the pinned-magnetic layer 12.

Magnetization of the pinned-magnetic layer 12 is fixed in a constant direction by the anti-ferro-magnetic layer 13. The magnetizing angle of the free-magnetic layer 11 changes in response to a medium magnetic field. The non-magnetic layer 14 is formed of a conductive material such as Cu or the like.

The magnetization of the free-magnetic layer is difficult to rotate in the bias direction at both end portions by a self-demagnetizing field. Accordingly, a response to the medium magnetic field also generates hysteresis, likely resulting in the generation of Barkhausen noise. Therefore, on both sides of the element 10, a ferro-magnetic layer 15a, 15b such as CoCrPt or the like is allocated as a bias application layer via an underlayer 16a, 16b such as Cr or the like. This bias magnetic field stabilizes magnetization of the free-magnetic layer to prevent generation of Barkhausen noise.

FIG. 3 is an explanatory diagram of the magnetic head viewed from the direction vertical to the film surface. The magnetic head includes, as shown in FIG. 2 and FIG. 3, the upper shield 3 and the lower shield 1 via insulating layers 18, 19 at the upper and lower portions of the element 10. In addition, the element 10 is electrically connected to an external detecting circuit through electrodes 17a, 17b, a bonding pad 20a, 20b and a conductive lead wire trace (not illustrated). As explained above, the magnetic head converts magnetic information written on a magnetic disk into an electrical signal through the magnetoresistive element.

In recent years, a read head is required that can read narrower gaps and narrower tracks in higher density magnetic recording medium. However, realization of such narrower gaps and narrower tracks makes effective application of a bias magnetic field to the magnetoresistive element difficult. Therefore, still higher coercive force and residual magnetic flux density of the ferro-magnetic layer are required.

Japanese Unexamined Patent Publication No. 1997-282612 discloses a bias magnetic field application layer formed of a soft-magnetic layer and a hard-magnetic layer. Moreover, Japanese Unexamined Patent Publication No. 2005-38508 discloses a bias magnetic field application layer formed of a hard-magnetic layer, a ferro-magnetic layer, and an underlayer. However, these technologies are characterized in that higher coercive force and residual magnetic flux density are attained by laminating multilayers of the soft-magnetic layer and hard-magnetic layer.

However, as the coercive force of the ferro-magnetic layer and the residual magnetic flux density are increased, the exchange coupling force of magnetization is also increased, and moreover, a grain size of the ferro-magnetic layer is also increased. Since element size is reduced to 200 nm×200 nm, or less, due to higher recording density of the magnetic recording apparatus, the amount of grains in the ferro-magnetic layer 15a, 15b in the element height direction becomes 10 or less. FIG. 4 is an explanatory diagram showing crystal grain size and magnetization of the ferro-magnetic layer of the prior art. As shown in FIG. 4, the crystal grain of the ferro-magnetic layer 15b is not perfectly magnetized in the bias direction and fluctuates in each grain. Accordingly, when the amount of grains in the ferro-magnetic layer 15b in the element height direction is about 10 or less, the magnetizing direction 21 is different in accordance with the position of the element. The free-magnetic layer 11 (sensing layer) becomes unstable, and Barkhausen noise is generated.

Accordingly, it is an object of the present invention to apply a more uniform bias magnetic field to the sensing layer while the coercive force and residual magnetic flux density of the ferromagnetic layer are maintained at higher values.

### SUMMARY OF THE INVENTION

In accordance with an aspect of an embodiment, a magnetoresistive element includes a sensing layer in which magnetization rotates in response to an external magnetic field, a bias application layer for applying a bias magnetic field to said sensing layer via an underlayer, and a magnetic layer is positioned between said underlayer and said bias application layer, wherein a crystal grain size of said magnetic layer is smaller than a crystal grain size of said bias application layer.

### BRIEF DESCRIPTION OF THE DRAWINGS

The present invention will be explained with reference to the accompanying drawings.

FIG. 1 is a cross-sectional view showing a structure of a magnetic head.

FIG. 2 is a side elevation showing a structure of the prior art of the giant magnetoresistive element used in the magnetic head.

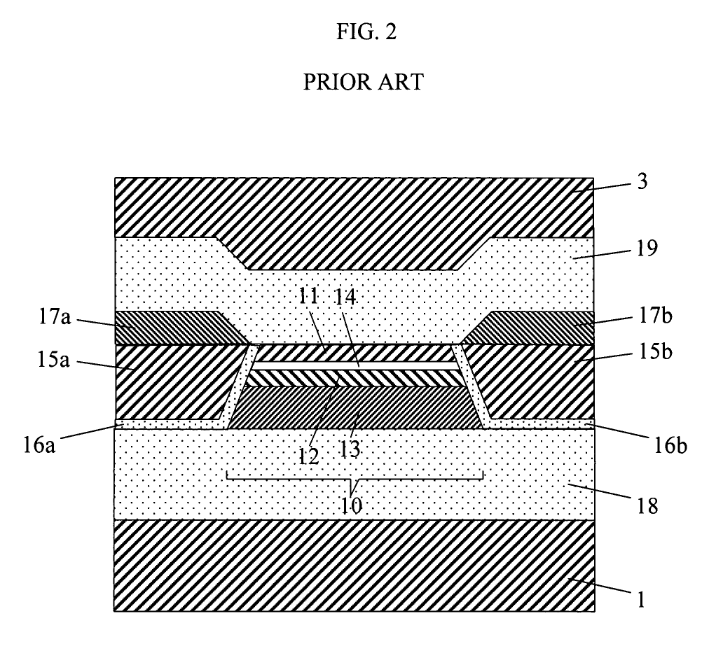

FIG. 3 is an explanatory diagram of the magnetic head using the magnetoresistive element of the prior art viewed from the direction vertical to the film surface.

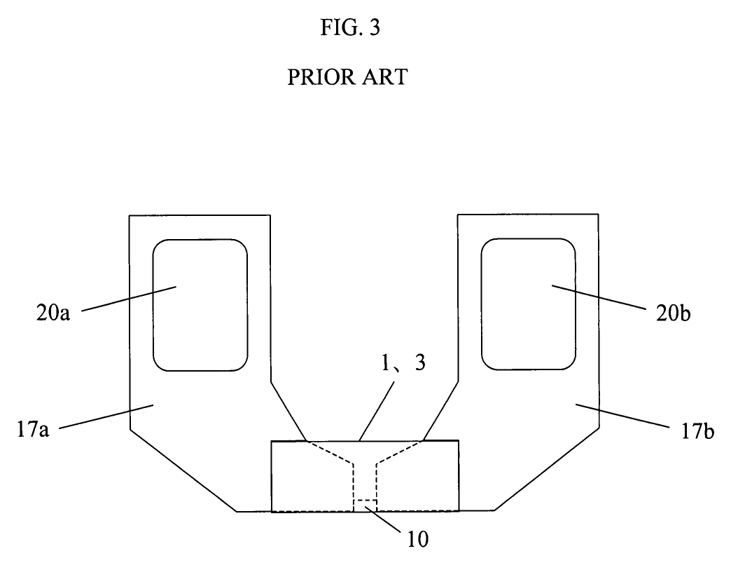

FIG. 4 is an explanatory diagram showing crystal gain size and magnetization of a ferro-magnetic layer of the prior art.

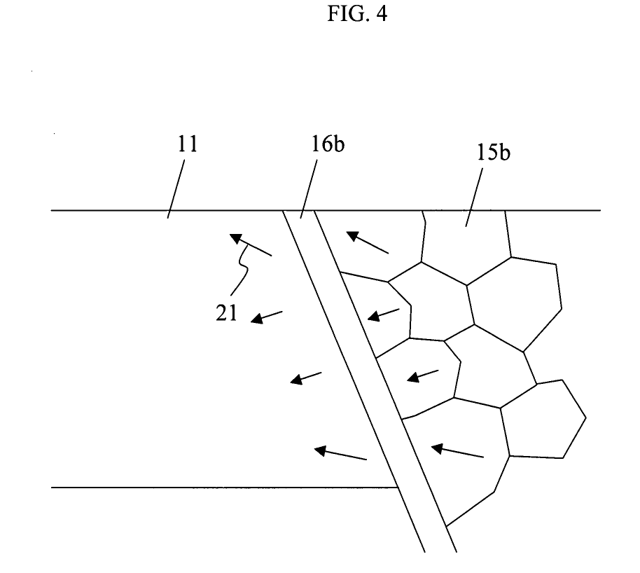

FIG. 5 is a side elevation showing a structure of an embodiment of the magnetic head using the magneto-resistive element of the present invention.

FIG. 6 is an explanatory diagram showing crystal grain size and magnetization of the ferro-magnetic layer and soft-magnetic layer of the present invention.

FIG. 7 is a distribution diagram in the core width direction of the bias magnetic field in the free-magnetic layer.

FIG. 8 is a perspective view of a magnetic recording apparatus using the magnetoresistive element of the present invention.

### DETAILED DESCRIPTION

The preferred embodiment of the present invention will be explained in detail with reference to the accompanying drawings.

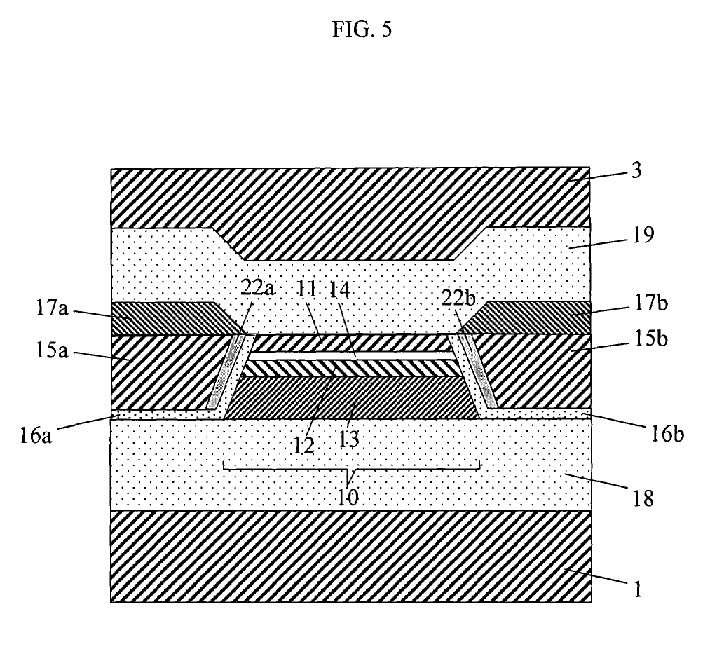

FIG. 5 shows a structure of an embodiment of a magnetic head utilizing the magnetoresistive element of the present invention. The magnetic head of the present invention comprises a lower shield layer 1, a lower gap layer 18, a magnetoresistive (MR) element 10, an underlayer 16a, 16b, a ferro-magnetic layer 15a, 15b, a magnetic layer 22a, 22b, an electrode 17a, 17b, an upper gap layer 19, and an upper magnetic shield 3 or the like. FIG. 5 is a side elevation of the magnetic head utilizing the magnetoresistsive element of this embodiment of the present invention viewed from the surface opposing a medium.

The lower shield layer 1 is formed of a soft-magnetic material such as NiFe, FeCo, FeCoNi, or the like, in a thickness of between about 1 to about 4 μm, for example, 3 μm. Thereafter, a non-magnetic insulating layer of Al₂O₃, AlN, SiO₂, or the like, is formed over the lower shield layer 1 as the lower gap layer 18 in thickness of between about 5 to about 25 nm.

The MR element 10 can be, for example, a giant magnetoresistive (GMR) film and a tunnel magnetoresistive film. This embodiment discloses the giant magnetoresistive (GMR) film composed of a free-magnetic layer 11 as the sensing layer, a pinned-magnetic layer 12, and an anti-ferro-magnetic layer 13 for fixing magnetization of the pinned-magnetic layer.

The MR element 10 is formed by sequentially laminating an underlayer (not illustrated), the anti-ferro-magnetic layer 13, pinned-magnetic layer 12, non-magnetic layer 14, free-magnetic layer 11 and a protection layer (not illustrated) on a lower gap layer 18. The magnetization of the free-magnetic layer 11 rotates in response to a magnetic field of medium. Meanwhile, the pinned-magnetic layer 12 is fixed in a constant direction through exchange coupling with the anti-ferro-magnetic layer 13 and does not respond to the magnetic field of the medium. Moreover, the free-magnetic layer 11 is magnetized in a bias direction that is almost orthogonal to the magnetizing direction of the pinned-magnetic layer 12.

The free-magnetic layer 11 uses a soft-magnetic material such as NiFe, CoFe, or the like, in a thickness of between about 3 to about 5 nm, while the pinned-magnetic layer 12 uses a soft-magnetic material such as CoFe, or the like, in a thickness of between about 2 to about 3 nm, and the anti-ferro-magnetic layer 13 uses an anti-ferro-magnetic material such as PdPtMn, IrMn, NiO, and FeMn, or the like, in a thickness of between about 10 to about 30 nm. The non-magnetic layer 14 uses a non-magnetic material such as Cu, Ru, Ir, or the like, in a thickness of between about 1 to about 2 nm. However, in the tunnel magnetoresistive film, the non-magnetic layer 14 uses an insulating material such as Al₂O₃, MgO, or the like, in the thickness of about 0.5 nm. The protection layer (not illustrated) uses Ta, Al₂O₃ in a thickness of between about 10 to about 20 nm. The pinned-magnetic layer 12 could also be a double-layer structure such as CoFe/Ru/CoFe, which includes an intermediate layer such as Ru.

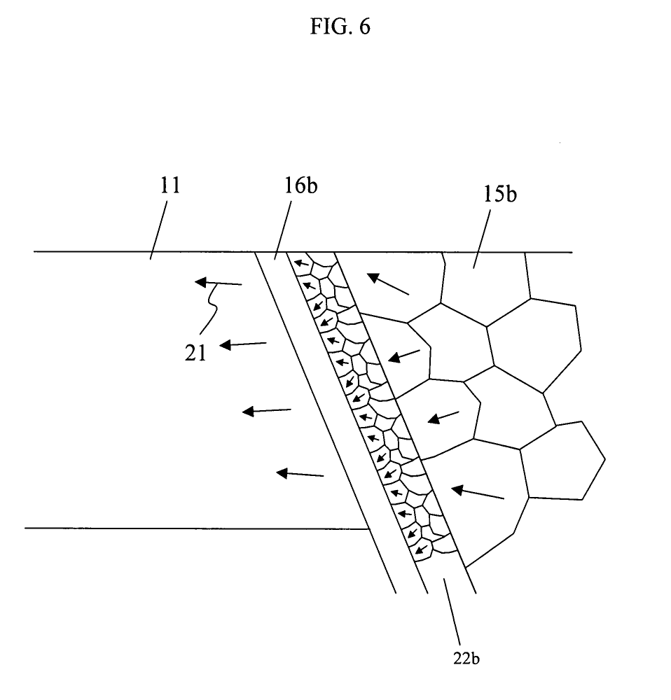

The ferro-magnetic layer 15a, 15b is allocated via the underlayer 16a, 16b on both sides of the bias direction to hold the magnetoresistive film. Thus, ferro-magnetic layer 15a, 15b acts as the bias application layer. A soft-magnetic layer is allocated as a magnetic layer 22a, 22b between the underlayer 16a, 16b and the ferro-magnetic layer 15a, 15b. FIG. 6 is an explanatory diagram showing grain size and magnetization of the ferro-magnetic layer and soft-magnetic layer of this embodiment of the present invention. The soft-magnetic layer allocated near the free-magnetic layer 11 has the crystal grain size of approximately 20 nm or less, which is smaller than that of the ferro-magnetic layer 15b. Accordingly, the component of the bias magnetic field in the element height direction is cancelled, a stable bias magnetic field is applied to the sensing layer in the core width direction and Barkhausen noise can be prevented by transferring the bias magnetic field from the ferro-magnetic layer to the sensing layer through such small grains. As explained above, the Barkhausen noise is controlled by applying the bias magnetic field to the free-magnetic layer 11.

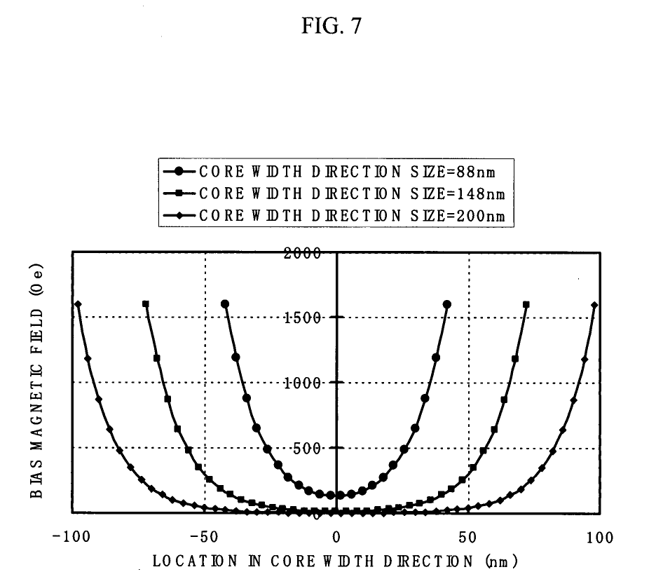

FIG. 7 is a distribution diagram showing distribution of the bias magnetic field to the free-magnetic layer in the core width direction in the reading magnetic heads of different element core widths. FIG. 7 shows the results of simulations under the conditions that the sizes of the element core width direction are 88 nm, 148 nm, and 200 nm, the size of the element height direction is 112 nm, and tBr of the ferro-magnetic layer as the bias application layer is 190 Gμm. A bias magnetic field such as about 1500 Oe is evenly applied at both end portions under any condition, but the intensity thereof is rapidly reduced as it goes to the area near the center of the element. In the region within about 20 nm from both end portions, the intensity of the magnetic field is rapidly reduced to half-value, or less, compared to the bias magnetic field at both end portions. Therefore, fluctuation in the element height direction of the bias magnetic field can be reduced by setting the grain size of the soft-magnetic layer to the similar degree or less.

As the ferro-magnetic layer 15a, 15b, a ferro-magnetic material such as CoPt, CoCrPt in a thickness of between about 10 nm to about 30 nm is used. Moreover, as the underlayer 16a, 16b, a non-magnetic layer such as Cr, Ti, and W in a thickness of between about 1 to about 2 nm is used and magnetization of the ferro-magnetic layer 15a, 15b is oriented within the film surface. Here, as the magnetic layer 22a, 22b, a metal material including at least any of Fe, Co, and Ni is used as the soft-magnetic layer.

Moreover, the ferro-magnetic layer 15a, 15b is magnetized in the bias direction. In this case, the magnetic layer 22a, 22b preferably has a coercive force of approximately 500 Oe, or less, for magnetization of the magnetic layer 22a, 22b in the bias direction. In addition, the magnetic layer 22a, 22b preferably also has a saturated magnetic flux density of about 5000 G, or more, for application of sufficient bias magnetic field to the free-magnetic layer 11. The reason is that the crystal grain size becomes smaller in the condition explained above.

Next, the magnetic recording apparatus mounting the magnetic head explained in this embodiment will be explained briefly.

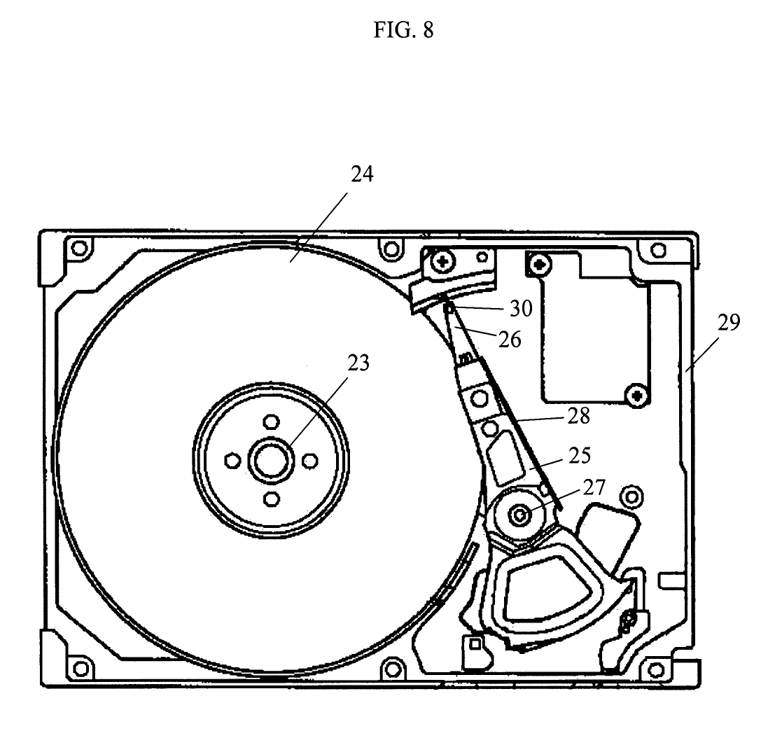

FIG. 8 is a perspective view of a magnetic recording apparatus utilizing an embodiment of the magnetic head of the present invention. The magnetic disk 24 includes magnetic information and is controlled to rotate at a high velocity with the spindle motor 23. The actuator arm 25 is provided with a suspension 26 formed of a flexible stainless material. Moreover, the actuator arm 25 is pinned to a case 29 to freely rotate with the pivot 27, and is capable of moving in approximately the radius direction of the magnetic disk 24. Thereby, a slider 30 mounted to the suspension 26 moves on the magnetic disk 24 to record and read information on the predetermined tracks. Within the case 29, a detecting circuit is mounted to detect recording and reading signals. The detecting circuit feeds a sense current to the magnetoresistive element within the magnetic head, and measures change of voltage in the magnetoresistive element to detect change of resistance value and recover the information from the medium.

The slider 30 is mounted to the suspension 26 at the lower part thereof to constitute a head suspension assembly. When the magnetic disk 24 rotates at a high velocity, air is drawn into a gap between the slider 30 and the magnetic disk 24, and the air pressure generated in this case levitates the slider 30. The magnetic head mounted to the front end part of slider 30 is connected electrically to the detecting circuit via the insulated conductive lead wire 28 on the suspension 26 and actuator arm 25.

According to the preferred embodiment of magnetoresistive element of the present invention, it is possible, even when the element size is set to 200 nm×200 nm or less, to provide the magnetoresistive element which is controlled in generation of the Barkhausen noise, the magnetic head and the magnetic recording apparatus provided with the relevant magnetoresistive element.

The magnetoresistive element, magnetic head, and magnetic recording apparatus of the present invention may be applied in common to the magnetoresistive element, magnetic head, and magnetic recording apparatus comprising the soft-magnetic layer (free-magnetic layer) which can freely change in the magnetizing direction in response to the medium magnetic field, for example the spin valve element and tunnel resistive element or the like.

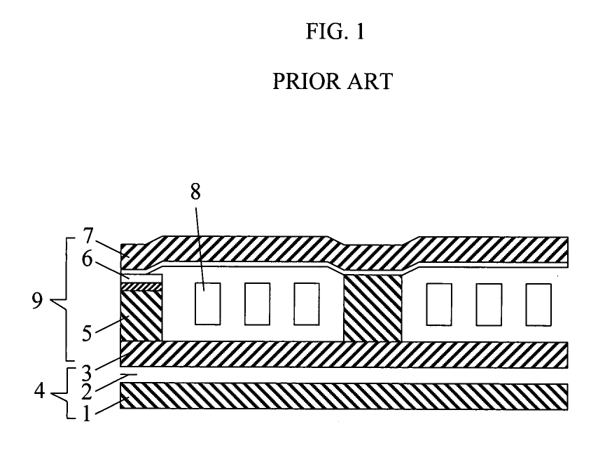

Moreover, the magnetoresistive element of the present invention may be used not only in a magnetic head for reading a magnetic field of a medium, but also in a magnetic device such as MRAM. In addition, the magnetoresistive element of the present invention may also be used as the magnetoresistive element provided in the read head in regard not only to the in-plane recording type magnetic head shown in FIG. 1 but also to the vertical recording type magnetic head.

What is claimed is:

1. A magnetoresistive element comprising:
a sensing layer in which magnetization rotates in response to an external magnetic field;
a bias application layer for applying a bias magnetic field to said sensing layer via an underlayer; and
a magnetic layer is positioned between said underlayer and said bias application layer, wherein a crystal grain size of said magnetic layer is smaller than a crystal grain size of said bias application layer.

2. The magnetoresistive element according to claim 1, wherein the crystal grain size of said magnetic layer is approximately 20 nm or less.

3. The magnetoresistive element according to claim 1, wherein said magnetic layer is formed of a soft-magnetic layer.

4. The magnetoresistive element according to claim 2, wherein said magnetic layer is formed of a soft-magnetic layer.

5. The magnetoresistive element according to claim 3, wherein said soft-magnetic layer includes at least any one of the following elements: Fe, Co, and Ni.

6. The magnetoresistive element according to claim 4, wherein said soft-magnetic layer includes at least any one of the following elements: Fe, Co, and Ni.

7. A magnetic head comprising:
a magnetoresistive element including a sensing layer in which magnetization rotates in response to an external magnetic field, a bias application layer for applying a bias magnetic field to said sensing layer via an underlayer, and a magnetic layer positioned between said underlayer and said bias application layer, wherein a crystal grain size of said magnetic layer is smaller than a crystal grain size of said bias application layer;
a pair of electrodes for feeding a current to said magnetoresistive element; and
a pair of conductive lead wires for transferring an electrical signal read from said magnetoresistive element via said electrodes.

8. The magnetic head according to claim 7, wherein crystal grain size of said magnetic layer is 20 nm or less.

9. The magnetic head according to claim 7, wherein said magnetic layer is formed of a soft-magnetic layer.

10. The magnetic head according to claim 8, wherein said magnetic layer is formed of a soft-magnetic layer.

11. The magnetic head according to claim 9, wherein said soft-magnetic layer includes at least any one of the following elements: Fe, Co, and Ni.

12. The magnetic head according to claim 10, wherein said soft-magnetic layer includes at least any one of the following elements: Fe, Co, and Ni.

13. A magnetic recording apparatus comprising:
a magnetic head for reading recorded information from magnetic disk including, a sensing layer in which magnetization rotates in response to an external magnetic field, a bias application layer for applying a bias magnetic field to said sensing layer via an underlayer, and a magnetic layer positioned between said underlayer and said bias application layer, wherein a crystal grain size of said magnetic layer is smaller than a crystal grain size of said bias application layer, a pair of electrodes for feeding a current to a sensing layer, and a pair of conductive lead wires for transferring the electrical signal read from said sensing layer via said electrodes;
a conductive flexible suspension bonded with said magnetic head;
a rotatable actuator arm for pinning an end part of said suspension.

14. The magnetic recording apparatus according to claim 13, wherein the crystal grain size of said magnetic layer is approximately 20 nm or less.

15. The magnetic recording apparatus according to claim 13, wherein said magnetic layer is formed of a soft-magnetic layer.

16. The magnetic recording apparatus according to claim 14, wherein said magnetic layer is formed of a soft-magnetic layer.

17. The magnetic recording apparatus according to claim 15, wherein said soft-magnetic layer includes at least any one of the following elements: Fe, Co, and Ni.

18. The magnetic recording apparatus according to claim 16, wherein said soft-magnetic layer includes at least any one of the following elements: Fe, Co, and Ni.
